(19) United States
(12) Patent Application Publication
(10) Pub. No.: US 2023/0282153 A1
(43) Pub. Date: Sep. 7, 2023

(54) METHODS AND SYSTEMS FOR NON-LINEAR COMPENSATION IN DISPLAY APPLICATIONS

(71) Applicant: Stereyo BV, Nazareth (BE)

(72) Inventors: Robbie THIELEMANS, Nazareth (BE); Vince DUNDEE, Glendale, CA (US)

(21) Appl. No.: 17/981,898

(22) Filed: Nov. 7, 2022

Related U.S. Application Data
(60) Provisional application No. 63/317,178, filed on Mar. 7, 2022.

(51) Int. Cl. G09G 3/32

(52) U.S. Cl. CPC G09G 3/32; G09G 2320/0666; G09G 2320/0242; G09G 2320/0233; G09G 2360/16; G09G 2300/0452; G09G 2320/0693

(57) ABSTRACT

Methods and systems are provided for determining non-linear display pixel driver compensation performed by a processing system of a light-emitting display having one or more colors, the light-emitting display including pixels controlled by pixel drivers. The method includes (i) measuring values for at least one of the one or more colors, (ii) calculating values for the at least one of the one or more colors, (iii) comparing measured and corresponding calculated values, and (iv) observing a deviation in the measured values due to non-linearities, and determining said deviation as the non-linear pixel driver compensation.

### TECHNICAL FIELD

The invention relates to displays, such as, for example, LED (light-emitting diode) displays, although not being limited to this particular display technology. More specifically, the invention relates to obtaining more accurate color and/or greyscale representation in such displays by means of (non-linear) correction or compensation methods, even and particularly which may be applied after calibration (based on linear equations), but also when no calibration is applied.

### BACKGROUND OF THE INVENTION

From previous disclosures and applications, it has become clear that calibrating a display for color and brightness, uniformity has to be performed in a real-time fashion. For LED displays—up to present day—the calculations are made in the linear color space and it is not taken into account that non-linearities exist in generating the respective light output of the individual R(ed), G(reen) and B(lue) color per individual pixel.

Traditional LED's color light output is generated using PWM (Pulse Width Modulation) that act on constant current drivers (in general pixel drivers, possibly also referred to as PWM drivers, or LED drivers In the LED industry (see e.g. “Handbook of Visual Display Technology”: Thielemans R. (2012) LED Display Applications and Design Considerations—Springer, Berlin, Heidelberg. https://doi.org/10.1007/978-3-540-79567-4_76) that LEDs change slightly in color when the drive current is changed. Hence, a constant current is applied. However, due to several reasons, the linearity between digitally generated PWM and light output measured on the individual LEDs is not guaranteed.

### SUMMARY OF THE INVENTION

Hence, the inventors of the present application have found that the ‘traditional’ X, Y, Z color correction calculations (e.g. known as standard calibration, usually calculated in linear space) that act on PWM and the supposed ‘constant current drivers’ are not entirely correct. Further correction or compensation (for non-linearities) is therefore needed.

The aim of the invention is to look for a practical way how to determine deviations due to non-linearities (caused by the pixel drivers), and subsequently, once determined, how to correct or compensate (real-time) for these deviations. It is further aimed, to define a physical (constant current driver) implementation (of the correction or compensation) that also reduces the computing complexity in LED driving systems.

In brief, the present disclosure provides a method and system for improved color and/or greyscale representation of light-emitting displays by means of non-linear compensation, and moreover, electronics systems for implementing such method, either global (FPGA based), or local (Chip Based).

In particular, the inventors of the present application have found that the use of calibration as known from the art (and which is in essence assumed linear relationships) is insufficient e.g. for high-quality display performance, an additional correction or compensation (due to non-linearities) is preferably determined and used. Further, the inventors have found that even in the case no calibration took place, non-linearities occur, and hence any way a correction or compensation is required for achieving better color and/or greyscale output of video or images being displayed. Contrary to the standard calibration steps, which uses (3×3) matrices due to the interplay between (primary) colors, performed per display pixel, for the additional correction or compensation it may be sufficient to do this for only one (primary) color and per cluster of display pixels. It is noted that the calibration may be depending on a display content context and/or display set-up, hence content dependent calibration may be used as known in the art. The non-linear compensation may be based on the brightness (Y-value of color space coordinates) defined by a mathematical formula. Alternatively, the compensation may be relied on what is stored in one or more lookup tables (or memory), each comprising of input values and corresponding output values taking into account the non-linearities. Considering the amount of storage space (required) for the non-linear compensation, the use of a plurality of small lookup tables (having reduced bit-representation) instead of using one single large one may be suggested, including performing interpolation calculations amongst these small lookup tables. Further acknowledging that the above still might be insufficient for high-quality display performance, an additional temperature correction may be applied.

For some aspects of the present invention further described below, referral could be made to earlier application from the same Applicant, amongst which for example WO2019/215219 A1, entitled “STANDALONE LIGHT-EMITTING ELEMENT DISPLAY TILE AND METHOD” and published 14 Nov. 2019, and US2020/0286424, entitled “REAL-TIME DEFORMABLE AND TRANSPARENT DISPLAY” and published 10 Sep. 2020, both of which are herein incorporated by reference. Whenever appearing relevant for one of the aspects of the present invention, this referral will be particularly and explicitly made below.

According to a first aspect of the invention, a method is provided for determining non-linear display pixel driver compensation performed by a processing system of (or for) a light-emitting display characterized by one or more colors, said light-emitting display comprising of pixels being controlled by pixel drivers. The ‘determination’ method comprises the following steps: (i) measuring (real-time) (on-display) (color) values for at least one of the one or more colors (and/or one or more pixels, i.e. a pixel or cluster of pixels); (ii) calculating (theoretical) (color) values for the at least one of the one or more colors (based on a linear relationship) (and/or one or more pixels); (iii) comparing measured and corresponding calculated values; (iv) observing (per color and for at least one color) a deviation in the measured values due to non-linearities (caused by the pixel drivers), and determining said deviation as the non-linear pixel driver compensation. For the values is referred to color space or linear space, defined by 3 coordinates (x, y, Y) or (X, Y, Z). In general, and preferably, the processing system will be internally provided in the display. However, it could be technically speaking to have a processing system outside or external from the display. In general, one pixel driver can be used for a cluster of pixels, for example being a multiple of 16, such as e.g. 64 or 256 pixels (per cluster).

According to an embodiment, the light-emitting display is characterized by at least three (primary) colors. The determining of the non-linear display pixel driver compensation (and hence all steps being part thereof, or involved here) may be performed for each display pixel or cluster of display pixels.

According to an embodiment, prior to all steps (i) to (iv), calibration is performed by means of the following steps: (a) reading, loading or inputting the (native) (color) values (in 3-coordinates representation) measured (which you could interpret here as a pre-calibration measurement, i.e. a measurement before the calibration calculations or computations take place) (with a spectrometer) for the one or more colors of (each of the pixels of) the display; (b) reading, loading or inputting the target values (as being perceived by a human eye and/or a camera recording the display output) for the one or more colors of (each of the pixels of) the display; and (c) for the one or more colors, computing (via matrix operations) corresponding calibration matrices based on the measured and target values (in particular, based on the difference between them). Taking into account this calibration, and referring back to the ‘determination’ method itself, when now step (ii) of calculating (theoretical) (color) values is performed, the calibration matrices can be used. The calibration matrices can be based on display content contexts and/or display set-ups, as known in content dependent calibration (see e.g. earlier patent applications WO2019/215219 A1 and US2020/0286424 mentioned above, from the same Applicant).

According to a second aspect of the invention, a method is provided for implementing non-linear display pixel driver compensation, performed by a processing system of (or for) a light-emitting display characterized by one or more colors, said light-emitting display comprising of pixels being controlled by pixel drivers. The ‘implementation’ method comprises the following steps: (i) determining the non-linear display pixel driver compensation based on the method of first aspect, or reading, loading or inputting the non-linear display pixel driver compensation, determined based on the method of first aspect, and (ii) compensating (or correcting) for said deviation determined as the non-linear display pixel driver compensation.

According to an embodiment, said compensating is based on the brightness (Y-value of color space coordinates) defined by a mathematical formula.

According to an embodiment, said compensating is based on the use of one or more lookup tables (of which data being stored in (non-volatile) memory), in particular on what is stored in (or represented by) the one or more lookup tables, each comprising of input values and corresponding output values taking into account the non-linearities. Moreover, said compensating can be based on what is stored in a plurality (i.e. at least two) of lookup tables having reduced bit-representation (in order to reduce the amount of memory required), in particular said compensating being defined from interpolation computations performed amongst these.

According to an embodiment, said compensating is performed for each display pixel or cluster of display pixels.

According to a third aspect of the invention, a method is provided for displaying an image on a light-emitting display with non-linear display pixel driver compensation. The ‘displaying’ method comprises the following steps: (i) determining the non-linear display pixel driver compensation based on the method of first aspect, or reading, loading or inputting the non-linear display pixel driver compensation, determined based on the method of first aspect; (ii) implementing the non-linear display pixel driver compensation based on the method of second aspect; and (iii) displaying the image.

According to an embodiment, an additional temperature correction is applied, for further improving the displaying of the image.

According to a fourth aspect of the invention, a system is provided for a light-emitting display, in particular for driving light-emitting elements or pixels thereof. The system is possibly part of the light-emitting display, could be incorporated or attached thereto. The system comprises an input protocol for receiving (video) input (to be displayed) and a PWM generating module for transferring said input into signals to be delivered to pixel drivers (e.g. one or more), herewith defining and controlling the light-emitting elements or pixels in the (light) output to be emitted (and displayed in the form of video) by them. The system also comprises a (additional) module for determining and implementing non-linear display pixel driver compensation (due to non-linearities caused by the pixel drivers) according to the method of first and second aspect respectively.

According to an embodiment, the system further comprises a module for performing calibration (for example as referred to in an embodiment of the method of first aspect) and herewith determining calibration matrices to be used in defining (eventually) the output to be emitted by the light-emitting elements or pixels (of the display).

According to an embodiment, said compensating of the method of second aspect, for implementing non-linear display pixel driver compensation, is particularly based on the use of one or more lookup tables and the data for this one or more lookup tables being stored in and hence to be fetched from a non-volatile memory of the processing system. Moreover, herewith, said one or more lookup tables each comprise input values and corresponding output values which take into account the non-linearities that need to be incorporated in the signals for the pixel drivers.

### BRIEF DESCRIPTION OF THE DRAWINGS

FIG. 1 illustrates an embodiment of traditional calibration video pipeline in accordance with the art, representing a flow for the determination of the color output Rout, Gout, Bout for the primary colors RGB based on the calibration matrix (A), when determined, and on the color input Rin, Gin, Bin for the primary colors RGB as received.

FIG. 2 illustrates a video pipeline embodiment in accordance with the art, representing a scheme that can be followed for the calculation of color output Rout, Gout, Bout based on the calibration matrix (A) and the color input Rin, Gin, Bin as received.

FIG. 3 illustrates a representation of the color Blue, herewith comparing color coordinates, having either same brightness (and same color) and being perceived similarly (B0 and B3), or else having different brightness (though same color) and being perceived differently (B1 and B2).

FIG. 4 illustrates a video pipeline embodiment in accordance with the art, representing a flow for the determination of the color output Rout, Gout, Bout for the primary colors RGB based on the calibration defined by 2 matrices Matrix1, Matrix2, and on the color input Rin, Gin, Bin for the primary colors RGB as received.

FIG. 5 illustrates examples of possible Factors listed to be used as weight in combination with RGB colors in order to define the (final) calibration.

FIGS. 6(a) and 6(b) illustrates graphical representation of the non-linear red channel output measured on a display, including a comparison with the linear theoretical expectation, in accordance with the invention.

FIG. 7 illustrates a video pipeline embodiment in accordance with the invention, representing a flow for the determination of the color output Rout, Gout, Bout for the primary colors RGB, wherein near the end or output, compensation blocks Comp R, Comp G, Comp B are foreseen.

FIG. 8 illustrates an exemplary embodiment representing block schematic or flow diagram for the implementation of the non-linear (sub-delta) compensation, in particular here for the Red light output, in accordance with the invention.

FIG. 9 illustrates an example of a LED with intelligent control, here by means of the LC8823-5050 RGB SMD LED Datasheet.

FIG. 10 illustrates the electronic diagram of TLC59731 from Texas Instruments, being a 3-channel, 8-bit, PWM LED driver with Single-Wire Interface.

FIG. 11 illustrates the block diagram of MBI5759 from Macroblock, which is an advanced LED driver built by 48 constant current source output channels and 32 switches packed into a compact BGA package.

FIG. 12 illustrates an embodiment and hence overall principal scheme of an oversimplified block diagram applicable for all existing (integrated or not) LED drivers, in accordance with the art.

FIG. 13 illustrates an embodiment of a block diagram for a pixel driver, in accordance with the invention.

FIG. 14 illustrates shows an exemplary embodiment of a curve exhibiting RC effect.

FIG. 15 illustrates a schematic embodiment of a method for determining non-linear display pixel driver compensation performed by a processing system of a light-emitting display, in accordance with the invention.

FIG. 16 illustrates another schematic embodiment of the method for determining non-linear display pixel driver compensation performed by a processing system of a light-emitting display, including initial calibration, in accordance with the invention.

FIG. 17 illustrates a schematic embodiment of a method for implementing non-linear display pixel driver compensation performed by a processing system of a light-emitting display, in accordance with the invention.

FIG. 18 illustrates a schematic embodiment of a method for displaying an image on a light-emitting display with non-linear display pixel driver compensation, in accordance with the invention.

FIGS. 19(a), 19(b), and 19(c) illustrate an embodiment of the processing system of a light-emitting display, being provided with non-linear display pixel driver compensation, in accordance with the invention.

FIG. 20 illustrates another video pipeline embodiment, in accordance with an embodiment of the invention.

### DETAILED DESCRIPTION

Detailed Description on Calibration

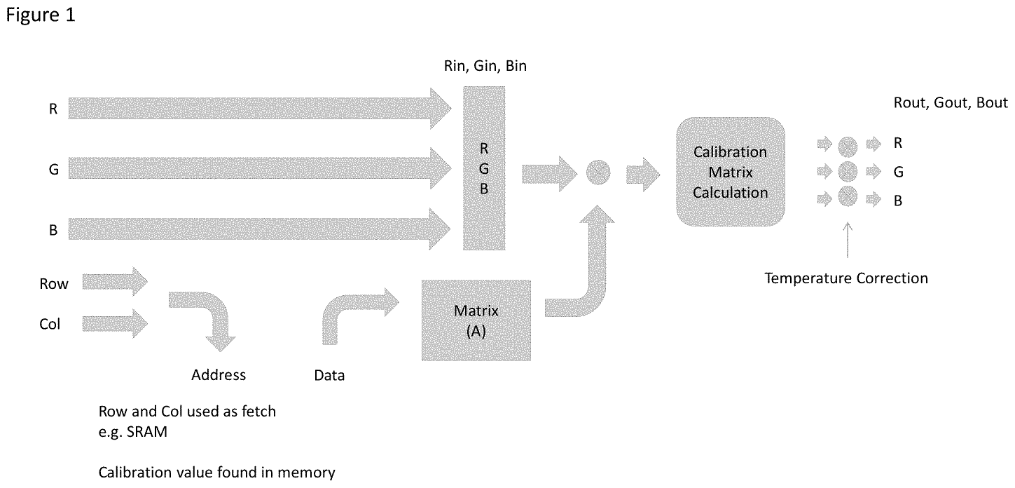

Applicant's earlier patent application is herein referred to, U.S. patent application Ser. No. 16/813,113, filed on Mar. 9, 2020, which is published as US patent application publication US2020/0286424, entitled “REAL-TIME DEFORMABLE AND TRANSPARENT DISPLAY” and published 10 Sep. 2020, which is herein incorporated by reference.

Whereas each individual LED may deviate in e.g. color or brightness, calibration is assumed as important. The traditional calibration video pipeline in accordance with the art is shown in FIG. 1, representing a flow for the determination of the color output Rout, Gout, Bout for the primary colors RGB based on the calibration matrix (A), when determined, and on the color input Rin, Gin, Bin for the primary colors RGB as received. As indicated here in FIG. 1, the calibration values for each RGB pixel are retrieved from a memory location, depending on the position (Row, Col) of the pixel itself. As a final step here in the flow, a temperature correction may be applied for achieving an even better color representation. The calibration principle to make light-emitting elements (e.g. LEDs, OLEDs) or pixels appear uniform on a display is common as well as the mathematics behind it. This principle is based upon individual measurements at a given drive current for every pixel in the display. By means of example, further explanation of the mathematical principle is given for traditional RGB LEDs, but it could also be applied to any other LEDs cluster with particular colors.

Assume all RGB LEDs have been measured at a certain defined current and defined temperature. This measurement can happen with e.g. a spectrometer. This yields x,y and Y measurement values for every of the R, G and B colors in one LED. In case of an RGB (Red, Green, Blue) display, the measurements e.g. performed in the CIE 1931 color space, wherein every color is represented in (x, y) and Y, are for example (x,y,Y are converted to X,Y,Z for working in linear space):

Rin=(Rinx,Riny,RinY)=(RinX,RinY,RinZ)

Gin=(Ginx,Giny,GinY)=(GinX,GinY,GinZ)

Bin=(Binx,BinY,BinY)=(BinX,BinY,BinZ)

It is noted that (x, y) are normalized values of X, Y, and Z being the so-called tristimulus values, whereas Y is a measure for the luminance of a color.

| Red | | | Green | | | Blue | | |
|---|---|---|---|---|---|---|---|---|
| x | y | Y | x | y | Y | x | y | Y |
| 0.6859 | 0.31 | 198.70 | 0.215 | 0.7171 | 250.00 | 0.131 | 0.107 | 66.00 |
| 439.64 | 198.70 | 2.63 | 74.95 | 250.00 | 23.67 | 80.80 | 66.00 | 470.02 |
| X | Y | Z | X | Y | Z | X | Y | Z |

Or in matrix format:

$$[ \begin{matrix}R in X & G in X & B in X \\ R in Y & G in Y & B in Y \\ R in Z & G in Z & B in Z\end{matrix} ] = [ \begin{matrix}439.64 & 74.95 & 80.8 \\ 198.7 & 250. & 66. \\ 2.63 & 23.67 & 470.02\end{matrix} ]$$

Color conversions are performed using following formulas:

$$x = \frac{X}{X + Y + Z}$$

$$y = \frac{Y}{X + Y + Z}$$

$$z = \frac{Z}{X + Y + Z} = 1 - x - y$$

$$X = Y \frac{x}{y}$$

$$Z = \frac{Y}{y} ( 1 - x - y )$$

It can now be defined what the color targets should be. (There are standards defined for e.g. HDTV, NTSC, PAL, REC2020 . . . ) These are the real colors that should be shown in the display.

| | Red | | | Green | | | Blue | | |
|---|---|---|---|---|---|---|---|---|---|
| NTSC 1953 | 0.67 | 0.32 | 1 | 0.22 | 0.71 | 1 | 0.14 | 0.08 | 1 |
| Adobe RGB 98 | 0.64 | 0.33 | 1 | 0.22 | 0.71 | 1 | 0.15 | 0.06 | 1 |
| PAL | 0.63 | 0.33 | 1 | 0.3 | 0.6 | 1 | 0.15 | 0.06 | 1 |

So, all LEDs need to be ‘calibrated’ to these individual points as explained before. One can set the colors to these standards, but it isn't a must as the mathematics are general.

Target Red color can be defined as:

Rtarg=(Rtargx,Rtargy,RtargY)=(RtargX,RtargY,RtargZ)

Next, the linear relationship can be defined between the target values and the ‘measured values’ (example here for Red channel).

RonR means how much contribution of Red from the native LED needs to be used in the desired (target) color of Red. GonR means how much Green of the original LED color needs to be added to this Red and so on.

RtargX=RinX×RonR+GinX×GonR+BinX×BonR

RtargY=RinY×RonR+GinY×GonR+BinY×BonR

RtargZ=RinZ x RonR+GinZ×GonR+BinZ×BonR

Or in matrix form this becomes:

$$[ \begin{matrix}R in X & G in X & B in X \\ R in Y & G in Y & B in Y \\ R in Z & G in Z & B in Z\end{matrix} ] \times [ \begin{matrix}R on R \\ G on R \\ B on R\end{matrix} ] = [ \begin{matrix}R t a r g X \\ R t a r g Y \\ R t a r g Z\end{matrix} ]$$

Performing this for also Green and Blue yield following matrix formula:

$$[ \begin{matrix}R in X & G in X & B in X \\ R in Y & G in Y & B in Y \\ R in Z & G in Z & B in Z\end{matrix} ] \times [ \begin{matrix}R on R & R on G & R on B \\ G on R & G on G & G on B \\ B on R & B on G & B on B\end{matrix} ] = [ \begin{matrix}R t a r g X & G t a r g X & B t a r g X \\ R t a r g Y & G t a r g Y & B t a r g Y \\ R t a r g Z & G t a r g Z & B t a r g Z\end{matrix} ]$$

Since the input is known and targets are known, the matrix can be solved for RonR etc.:

$$( A ) = [ \begin{matrix}R on R & R on G & R on B \\ G on R & G on G & G on B \\ B on R & B on G & B on B\end{matrix} ] = {[ \begin{matrix}R in X & G in X & B in X \\ R in Y & G in Y & B in Y \\ R in Z & G in Z & B in Z\end{matrix} ]}^{- 1} \times [ \begin{matrix}R t a r g X & G t a r g X & B t a r g X \\ R t a r g Y & G t a r g Y & B t a r g Y \\ R t a r g Z & G t a r g Z & B t a r g Z\end{matrix} ]$$

The targets could look as follows:

(note here that the brightness Y for all the targets has been normalized to 1)

| Red | | | Green | | | Blue | | |
|---|---|---|---|---|---|---|---|---|
| x | y | Y | x | y | Y | x | y | Y |
| 0.64 | 0.33 | 1.00 | 0.30 | 0.60 | 1.00 | 0.14 | 0.12 | 1.00 |
| 1.94 | 1.00 | 0.09 | 0.50 | 1.00 | 0.17 | 1.17 | 1.00 | 6.17 |
| X | Y | Z | X | Y | Z | X | Y | Z |

We already know from above that

$$[ \begin{matrix}R in X & G in X & B in X \\ R in Y & G in Y & B in Y \\ R in Z & G in Z & B in Z\end{matrix} ] is : [ \begin{matrix}439.64 & 74.95 & 80.8 \\ 198.7 & 250. & 66. \\ 2.63 & 23.67 & 470.02\end{matrix} ]$$

$${[ \begin{matrix}R in X & G in X & B in X \\ R in Y & G in Y & B in Y \\ R in Z & G in Z & B in Z\end{matrix} ]}^{- 1} then becomes : [ \begin{matrix}0.002616 & - 0.00075 & - 0.00034 \\ - 0.0021 & 0.004658 & - 0.00029 \\ 9.13 E - 05 & - 0.00023 & 0.002144\end{matrix} ]$$

And the final outcome for (A) then becomes:

| | | | | | |
|---|---|---|---|---|---|
| RonR | 0.43% | RonG | 0.05% | RonB | 0.02% |
| GonR | 0.06% | GonG | 0.36% | GonB | 0.04% |
| BonR | 0.01% | BonG | 0.02% | BonB | 1.31% |

Since the Y values in the targets have been normalized, extra information can now be added to not only set the LED calibrated colors to a target color, but use the brightness of each individual target color to set the display to a fixed white point when all RGB colors are on.

In this example, the display is set to the following white point:

| | | |
|---|---|---|
| x | y | Y |
| 0.423 | 0.399 | 480.00 |
| 508.87 | 480.00 | 214.14 |
| X | Y | Z |

$$[ \begin{matrix}R X & G X & B X \\ R Y & G Y & B Y \\ R Z & G Z & B Z\end{matrix} ] \times [ \begin{matrix}R \\ G \\ B\end{matrix} ] = [ \begin{matrix}W X \\ W Y \\ W Z\end{matrix} ]$$

WX, WY, WZ is the white point. The RX, GX, . . . is in this case the target color matrix as these target colors are going to be used, and the brightness of the targets is changed to get to the right white point. Hence, the equation needs to be solved for RGB.

$$[ \begin{matrix}R \\ G \\ B\end{matrix} ] = {[ \begin{matrix}R X & G X & B X \\ R Y & G Y & B Y \\ R Z & G Z & B Z\end{matrix} ]}^{- 1} \times [ \begin{matrix}W X \\ W Y \\ W Z\end{matrix} ]$$

$$[ \begin{matrix}R X & G X & B X \\ R Y & G Y & B Y \\ R Z & G Z & B Z\end{matrix} ] then becomes : [ \begin{matrix}1.94 & 0.5 & 1.17 \\ 1. & 1. & 1. \\ 0.09 & 0.17 & 6.17\end{matrix} ]$$

$${[ \begin{matrix}R X & G X & B X \\ R Y & G Y & B Y \\ R Z & G Z & B Z\end{matrix} ]}^{- 1} then becomes : [ \begin{matrix}0.690697674 & - 0.332558 & - 0.07674 \\ - 0.699418605 & 1.364535 & - 0.08895 \\ 0.00872093 & - 0.031977 & 0.165698\end{matrix} ]$$

$$[ \begin{matrix}R \\ G \\ B\end{matrix} ] then becomes : [ \begin{matrix}175.4153 \\ 280.014 \\ 24.5707\end{matrix} ]$$

So now, the final target with Y information added is:

| x | y | Y | x | y | Y | x | y | Y |
|---|---|---|---|---|---|---|---|---|
| 0.64 | 0.33 | 175.4153 | 0.30 | 0.60 | 280.0140 | 0.14 | 0.12 | 24.5707 |

The final thing to do, is to apply (i.e. scaling) the final multiplication factors to (A):

| | | | | | | | | |
|---|---|---|---|---|---|---|---|---|
| Rr | 75.27% | RonR | Gr | 13.97% | RonG | Br | 0.44% | RonB |
| Rg | 9.68% | GonR | Gg | 99.62% | GonG | Bg | 0.98% | GonB |
| Rb | 2.48% | BonR | Gb | 4.83% | BonG | Bb | 32.18% | BonB |

It is noted
that Rr=RonR, Rg=GonR, Rb=BonR and
that Gr=RonG, Gg=GonG, Gb=BonG and
that Br=RonB, Bg=GonB, Bb=BonB.

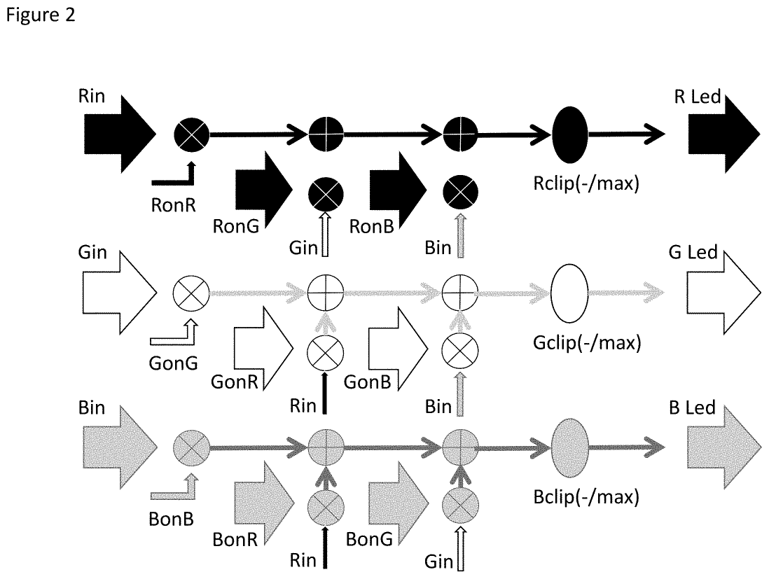

And this is the matrix (A) that can be used in the video pipeline of FIG. 2, representing a scheme that can be followed for the calculation of color output Rout, Gout, Bout based on the calibration matrix (A) and the color input Rin, Gin, Bin as received:

$$( R out , G out , B out ) = [ \begin{matrix}R on R & R on G & R on B \\ G on R & G on G & G on B \\ B on R & B on G & B on B\end{matrix} ] \times ( R in , G in , B in )$$

It is noted that the scheme of FIG. 2 is protected against getting stuck by means of providing Rclip, Gclip, Bclip in case the maximum value would be exceeded, or in case a negative result is achieved.

Herewith, the math is set straight for the ‘straightforward’ calibration.

The next step is to make the calibration content dependent by means of so-called content dependent calibration.

The reason why this was previously invented, as for example described in earlier patent application US2020/0286424 from the same Applicant (and in the meantime frequently tested and implemented) is twofold: 1/ visual (perceptual issue) when calibrating blue colors, resulting in perceptual color depth improvement, and 2/ because of issues related to Blue calibration. Both are now further discussed.

1/ Visual (Perceptual Issue) when Calibrating Blue Colors, Resulting in Perceptual Color Depth Improvement

The background of this invention is derived from the visual parameters explained in “Handbook of Visual Display Technology”: Thielemans R. (2012) LED Display Applications and Design Considerations—Springer, Berlin, Heidelberg, which is incorporated herein by reference. Here's a small summary of the human eye factors that are quantified, but (as later discussed) not to the full.
Color perception of the human eye is most sensitive in x direction and less in y direction (see e.g. MacAdam in “Handbook of Visual Display Technology”). However—and this has not been quantified to the full extent yet—this assumes all colors have the same luminance. When luminance of colors is varied, it is proven that the human eye color perception changes, but there is no math available for this.
Regarding resolution, or in other words how humans perceive the sharpness of a picture or image, this is the most sensitive in the Red component. The least sensitive is the Blue component. Best example to show this is to read blue text in black background. This is much more difficult compared to reading a red text on black background.
The human eye is also not sensitive to gradual luminance variations. Best example is e.g. a projector or beamer. The measured brightness in the corners is only 25% compared to the brightness in the center (100%). Humans will perceive this as ‘uniform’. Immediate differences in brightness will be perceived much faster (within tolerance limits).

2/ Issues Related to Blue Calibration

Assume you have 2 different blue LEDs that one wants to calibrate toward the same Blue color target. In order to achieve a same target, some minor Red and Green additions need to be applied to get to the right color. When measured with spectrometer (and also on some cameras), these LEDs will be perfectly adjusted and both having the same X, Y and Z. However, when viewed by a human, the Blue LED with most ‘Red’ addition will be perceived almost as dark, reddish in comparison to ‘whitish’ Blue LED where Green is more added. This phenomenon is also viewing distance dependent. The physical phenomenon happening is that the ‘human’ eye ‘locks’ onto the narrow band red emitter (remember human eye is sensitive for ‘resolution’). This ‘lock’ to the Red frequency has the effect that perceived Blue components are not ‘visible’ anymore and thus yielding a totally different visual perception. The CIE standard is made for wide band color emitters and not narrow band emitters, and hence does not take this ‘perception’ into account. Also—as stated earlier—it doesn't take luminance into account. So, although there is lots of (proved) math available on colors, still human perception is ‘king’. As a conclusion, we can say that although one can calibrate Blue LEDs to be totally equal according to CIE, still perception of color is different.

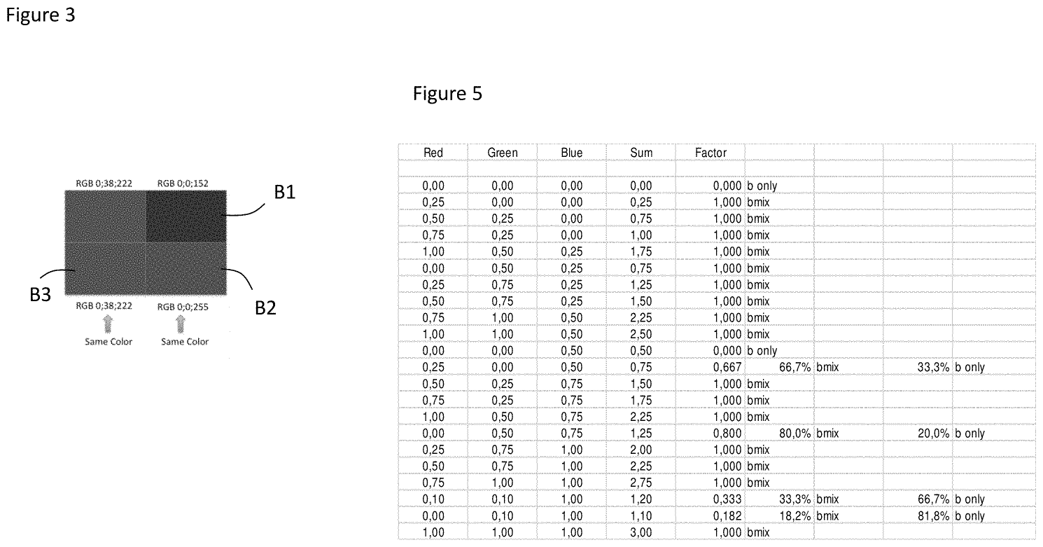

On the other hand, a variation of brightness in Blue is perceived as a color variation and this is shown in FIG. 3. The same RGB color in Blue with different brightness (0,0,152) indicated as B1 versus (0,0,255) indicated as B2 is perceived deeper Blue. And this color (0,0,255) B2 matches ‘visually’ closer to (0,38,255) indicated as B3 compared to (0,0,152) B1 while technically (0,0,152) B1 and (0,0,255) B2 are the same colors.

This means—for calibration purposes of displays—that in the case Blue batches of colors need to be calibrated, brightness variations will yield much better ‘perceived’ uniformity. As a result, LEDs that need this Blue brightness variation, will need a different matrix. Hence the need of two matrices. But varying brightness of a target color has the effect that (when used with also R and G) the white point changes. So, the LEDs that need Blue calibration by changing its Blue brightness will give a totally different white point. This is not at all desirable. Therefore, the solution exists in using a factor that is content dependent. This factor will define when to use the ‘Blue’ matrix or the ‘normal’ matrix.

We can now better understand that this principle is not only useful for ‘calibrating’ a display, but it can also be used to improve color depth perception (and this also works on Green, Red . . . ). As an example, it is known from the LED industry that traditional Blue LEDs are (often) not ‘deep’ enough in color. Usually they are above 470 nm, while desirable is 460 nm. Changing a 470 nm Blue LED to play at low brightness gives the visual impression that it plays at 460 nm.

An important note is made in that, since now ‘visual perception’ is brought into the picture, the strict wording of ‘calibrating’ a display is no longer applicable here since the word ‘calibration’ implies perfect/measurable uniform settings based upon straight measurements and mathematically correct adjustments.

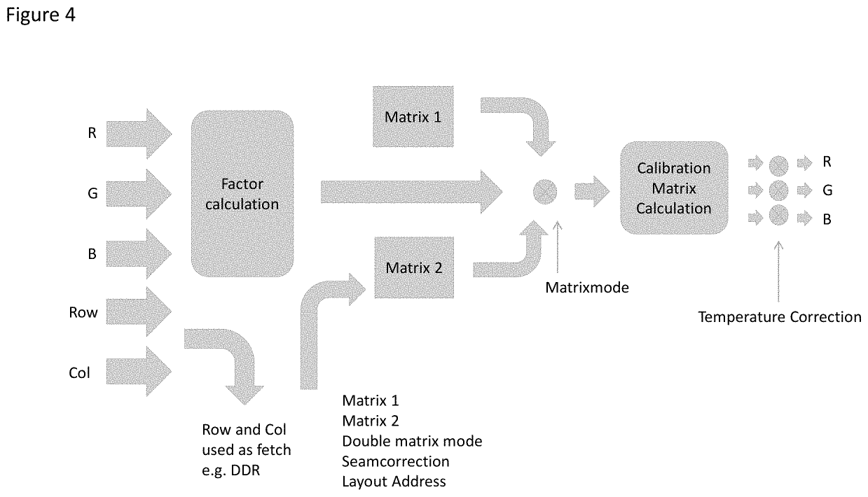

We end up with an example of how content dependent calibration can be achieved while making use of the video pipeline as depicted in FIG. 4, representing a flow for the determination of the color output Rout, Gout, Bout for the primary colors RGB based on the calibration defined by 2 matrices Matrix1, Matrix2, and on the color input Rin, Gin, Bin for the primary colors RGB as received. The final calibration matrix Mfinal is then e.g. defined by these 2 matrices and their weight, defined by the so-called Factor. By means of example, we can have Mfinal=Factor×Matrix1+(1−Factor)×Matrix2.

It is noted that the matrices (due to variations in LEDs) are different for every individual RGB LED. The example below is explained using one LED.

One defines a matrix which is to be used when only Blue needs to be shown (MBonly) and one defines a matrix when Blue is used whilst also showing Green and Red (MBmix). The matrices are derived the same way as previously explained in the ‘traditional’ example. For the sake of example here, the matrices can be derived by altering the target colors brightness of Blue.

The target for MBmix will use the same target values as in previous example (cfr. white point):

| x | y | Y | x | y | Y | x | y | Y |
|---|---|---|---|---|---|---|---|---|
| 0.64 | 0.33 | 175.4153 | 0.30 | 0.60 | 280.0140 | 0.14 | 0.12 | 24.5707 |

And this yields the MBmix matrix:

| | | | | | | | | |
|---|---|---|---|---|---|---|---|---|
| Rr | 75.27% | RonR | Gr | 13.97% | RonG | Br | 0.44% | RonB |
| Rg | 9.68% | GonR | Gg | 99.62% | GonG | Bg | 0.98% | GonB |
| Rb | 2.48% | BonR | Gb | 4.83% | BonG | Bb | 32.18% | BonB |

For the Blue only matrix (MBonly), the targets are set to:

| x | y | Y | x | y | Y | x | y | Y |
|---|---|---|---|---|---|---|---|---|
| 0.64 | 0.33 | 175.4153 | 0.30 | 0.60 | 280.0140 | 0.14 | 0.12 | 12.2854 |

This will give a totally wrong white point, but the target Blue will be set to 50% in this example.

And this yields the MBonly matrix:

| | | | | | | | | |
|---|---|---|---|---|---|---|---|---|
| Rr | 75.27% | RonR | Gr | 13.97% | RonG | Br | 0.44% | RonB |
| Rg | 9.68% | GonR | Gg | 99.62% | GonG | Bg | 0.98% | GonB |
| Rb | 1.23% | BonR | Gb | 2.40% | BonG | Bb | 15.97% | BonB |

Since only the luminance of target Blue has been changed, BonR, BonG and BonB only are affected in this example. It is to the user's imagination to modify and play with all kind of settings. One can even gradually change e.g. Blue to Green using this pipeline when a certain parameter in the content changes.

The next question to answer is, how to define when to use what matrix. Since in this example we want to show a perceived deep Blue color, the following is assumed:
MBonly needs to be used for 100% when the content to be shown is only Blue
MBmix needs to be used for 100% when there is a substantial mix of Red and Green

So, the final matrix to be used is:

Mfinal=Factor×MBmix+(1−Factor)MBonly

When Factor=1, this means Mfinal=Mbmix. When Factor=0, Mfinal=MBonly.

Next, we define a formula that takes the above assumptions into account and that we can also implement in real-time:

Factor=max(2×(R+G)/(R+G+B); 1)

Factor=0 when there is only Blue to be shown.

0<Factor<1 when Blue has ‘slight’ involvement in the content to be shown.

Factor≥1 (clipped) when Blue is substantial in the mix of colors.

All kinds of other formula can be imagined, but this example has the advantage of being implemented fairly easy in real-time FPGA computation. Examples of Factors can be found in the table given in FIG. 5.

While referring to the table of FIG. 5, in case Red=0.25, Green=0 and Blue=0.5 then Factor becomes 0.667.

The final calculation Mfinal then becomes:

| | | | | | | | | |
|---|---|---|---|---|---|---|---|---|
| Rr | 75.27% | RonR | Gr | 13.97% | RonG | Br | 0.44% | RonB |
| Rg | 9.68% | GonR | Gg | 99.62% | GonG | Bg | 0.98% | GonB |
| Rb | 2.07% | BonR | Gb | 4.03% | BonG | Bb | 26.83% | BonB |

Detailed Description of Embodiments and Examples Providing Solutions to Problems

As noted above, reference is made to earlier application from the same Applicant, amongst which for example WO2019/215219 A1, entitled “STANDALONE LIGHT-EMITTING ELEMENT DISPLAY TILE AND METHOD” and published 14 Nov. 2019, and US2020/0286424, entitled “REAL-TIME DEFORMABLE AND TRANSPARENT DISPLAY” and published 10 Sep. 2020. Whenever appearing relevant for one of the aspects of the present invention, this referral will be particularly and explicitly made below.

The Inventors' Identified Problem

When applying the calibration principle as described earlier (in detailed background description), measurement of the final result of e.g. Rtarg, Gtarg, Btarg and/or Wtarg (but also other calculated output values) show that there is a deviation to what is measured and what is really desired. This means that e.g. Rtarg-measured≠Rtarg-calculated. This is due to system non-linearities in the display after the PWM generation through the constant current driver to the LEDs.

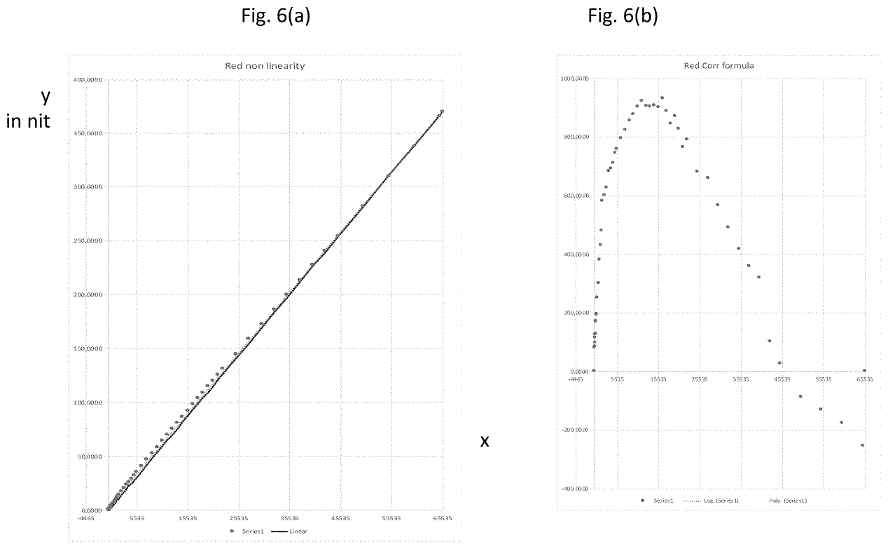

Assuming, the PWM is perfectly calculated, this means there is an introduction of non-linearities. FIGS. 6(a) and 6(b) illustrate such non-linearities, in particular FIG. 6(a) shows a graph of e.g. a non-linearity measured on Red color in a display. On the horizontal x-axis in this graph, we have the bit-number (here 16-bit) for Red represented, which is used as input for the constant current driver (or pixel driver in general). This bit-number is also known and referred to as PWM-number. On the graph's vertical y-axis, the Red luminance light output is given in nit (=candela per m²). The dots show the actual measurement (including non-linearities), whilst the solid line is the linear (theoretical and expected) case. FIG. 6(b) shows the deviation of the ‘Red light output’ compared to the linear case.

A Proposed Solution

According to the above an extra calculation step for these non-linearities has to be implemented.

A potential solution can be to define 3 factors and adding multiple matrices to be applied and acting upon these. A drawback of this solution is that this augments the digital implementation complexity (latency and speed) for full recalculation. The factors then determine the amount or weight to take from e.g. multiple matrices defined in the XYZ (linear) space.

The number of matrices and/or matrix elements can be arbitrarily chosen dependent on the accuracy required and the factors need then to determine what matrices to use to interpolate from. All these computations need to be done on top of the earlier describing visual perception improvement should one require these. A further drawback is the amount of memory and fetch operations that need to take place for one pixel to compute. Hence, this also has a drawback on system performance in the case one needs to process a lot of pixels.

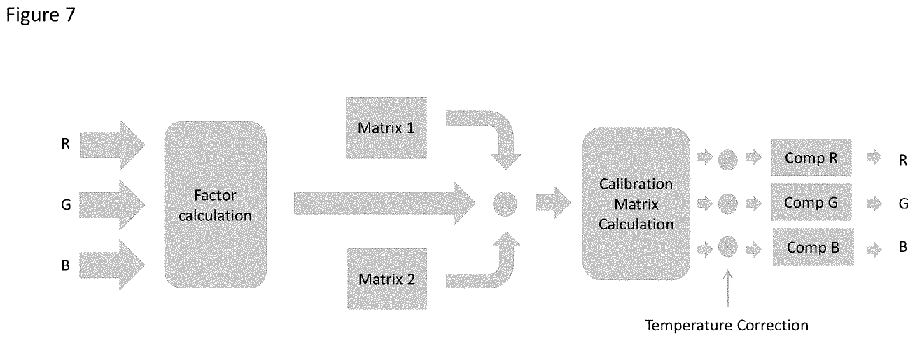

A simplification could be to assume the color (x,y) coordinates aren't changing (too much) due to these non-linearities. In that case, we only need to act on the Y value of the real primary color. The full pipeline then looks as in FIG. 7, representing partially the flow of earlier discussed FIG. 4, for the determination of the color output Rout, Gout, Bout for the primary colors RGB based on the calibration defined by 2 matrices Matrix1, Matrix2, and on the color input Rin, Gin, Bin for the primary colors RGB as received. For simplicity in the diagram, here in FIG. 7, the DDR (memory) access lines have been omitted. Near the output of the scheme an additional step or calculation is foreseen by means compensation blocks Comp R, Comp G, Comp B.

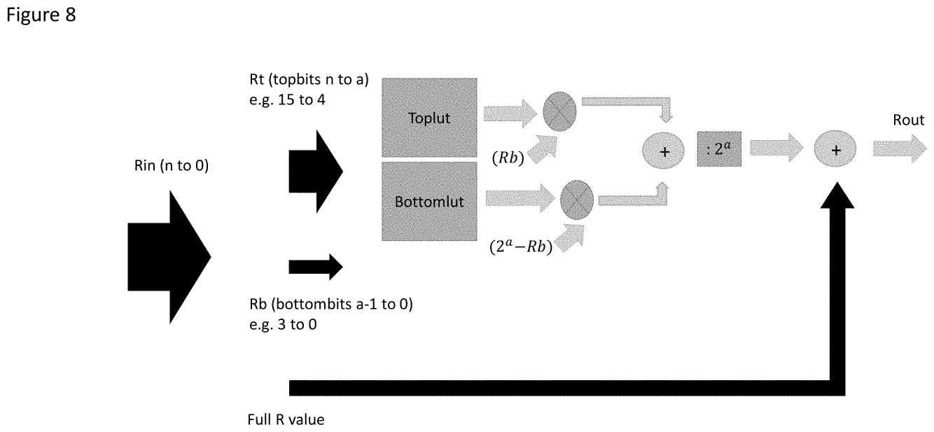

At this point we added 3 compensation blocks Comp R, Comp G, Comp B acting on all individual primary colors RGB respectively. There are multiple ways on how to implement the compensation blocks.
A. Mathematical formula approach
   Y=axⁿ+bxⁿ⁻¹+cxⁿ⁻²+ . . . wherein n needs to be set to an integer number to yield closest fit to the final curve.
B. Lookup table approach
   We define a lookup table with input values and output values. In reality (digital world), when assuming the PWM values are calculated in 16 bit this means we need to make a 65536 long RAM lookup table with 16-bit output. E.g. at location 32768, the output value is 30000 (instead of 32768 which is the linear case).
C. Sub-delta implementation
   This implementation is drawn as block schematic in FIG. 8, representing an exemplary embodiment of flow diagram for the implementation of the sub-delta compensation, in particular here for the Red light output.

Both A and B approaches require substantial hardware resources being either a computation pipeline or a substantial big memory. The next implementation C, also called sub-delta, is an approach that is limited in computation resources and RAM resources and can be performed with only a few clocks of latency.

As mentioned, the example diagram of FIG. 8 is shown for the Red channel, but is applicable for all colors. The flow and hence sequence of calculations illustrated in this diagram, is now further discussed.

Assume a digital bitstream of R (Red channel) values of 16 bit: Rin (15 to 0), having 16 parallel bit lanes, and n=15. We split this R channel up into 2 parts: a top-bit channel Rt of n to a, wherein a=4 here by means of example. So, we end up with a top-bit channel Rt of 12 bits, i.e. Rt (15 to 4), and a bottom-bit channel of 4 bits, i.e. Rb (3 to 0). So, in this example, the top part Rt has a width of 12 bits (values between 0 and 4095, or in total 4096=2¹² values) and the bottom part Rb has a width of 4 bits (values between 0 and 15, or in total 16=2⁴ values). Whereas Rt being defined from “n to a” bits, and Rb comprising “a” bits (0 being included), Rin can be defined as Rt×2^{a}+Rb.

As depicted in the diagram of FIG. 8, the top-bit channel Rt enters 2 lookup tables (lut): Toplut of 4096 words and Bottomlut of 4096 words. Each word being e.g. 12 bits signed. So, we now have 2 lookup tables each being 4096×12 bits in size which is substantially less than the 65536×16 values proposed in solution B above. Making use of two or more lookup tables having a reduced bit-representation (instead of when using just one) hence leads to less space needed and avoiding heavy processing (with large numbers). Another way of saving (memory) space and processing time, is to particularly work (in the calculations) with the deviation of the non-linear versus the linear case (or difference between them), instead of using the absolute numbers of linear output and non-linearities making this difference.

It is noted that these 2 lookup tables (Toplut and Bottomlut) can be used to make an interpolation between the values contained in their respective and corresponding locations determined by the Rt value. In addition, the Rb value can be used to determine such interpolation, in that the Rb value can be used to interpolate between a value from the Toplut (i.e. at a certain location thereof) and a value from the Bottomlut (at corresponding location thereof).

Assume that for the Red channel e.g. Rb=10 and Rt=1500 by means of example. We assume R Toplut has at the address 1500 (Rt) value 2900 and R Bottomlut has value 2800 at corresponding location 1500 (Rt). Both values will emerge at the output at the lookup tables when they are addressed with Rt=1500, being 2900 and 2800 respectively. As shown in the diagram of FIG. 8, the R Toplut value (here e.g. 2900) then gets multiplied by the Rb value (having 2^{a}=2⁴ possibilities in total) and the R Bottomlut value (here e.g. 2800) gets multiplied by (2^{a}−R^{b})=2⁴−10=16−10=6.

At this point, we end up with: (2900×10+2800×6) which is then divided by (2^{a}=16) for normalization purposes as part of the interpolation. The formula becomes: (2900×10+2800×6)/16 which we call a delta value, to be added to the original color value to compensate for the non-linearities.

Eventually, for the output Rout, we add this delta value to the original input value Rin which is Rt×2^{a}+Rb. Hence, the output value Rout becomes:

$$R out = R in + \frac{Top lut ( R t ) * Rb + Bottom lut ( R t ) * ( {2}^{a} - R b )}{{2}^{a}}$$

$$R in = Rt * {2}^{a} + R b$$

As a result, Rout=(1500*16+10)+(2900*10+2800*6)/16=24010+2862=26872.

The 2862 being the delta and is moreover the 2nd compensation on the color, and hence further referred to as sub-delta.

In case all individual LED primary colors have the same behavior, only 3 sets of lookup tables have to be made wherein every individual LED computation passes through the same table. It is noted that—in case wherein the compensation needs to be different—sets of computation lookup tables can be made and selected according to the LED that needs a certain compensation.

FPGA Implementation

All of the video pipeline above can be implemented in an FPGA (Field Programmable Gate Array) or standard ASIC. However, when the number of pixels to be computed with calibration and/or the sub-delta correction, this requires lots of memory access per pixel, especially for the calibration part. In case of e.g. using the visual perception calibration, this means that for every RGB pixel to be computed, at least 18 values (2 Matrices of 9 values) need to be fetched from a precomputed location in memory. Although this can be implemented, it has a drawback on computation speeds and/or pixel amount limitation. In order to reduce FPGA or ASIC complexity, part of the computation and non-linearity compensation can be done more locally at the LED level or around clusters of multiple LEDs, as described in next paragraph.

Chip Implementation

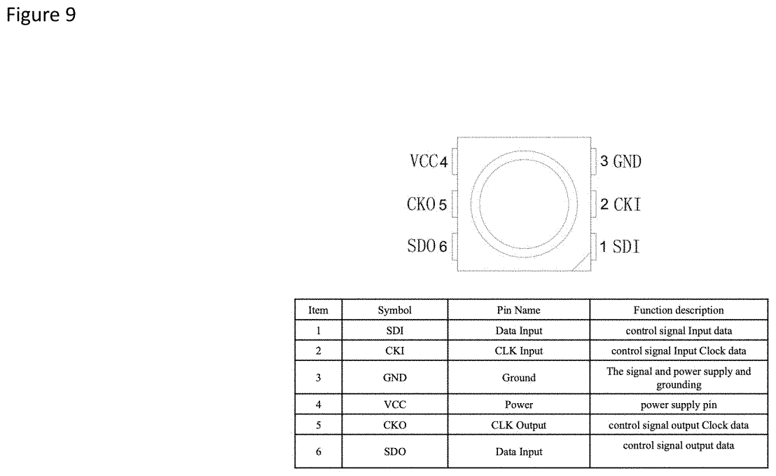

Single pixel LEDs with PWM generation already exist for a long time. Examples of these are e.g. LC8823 LEDs. These are called LEDs with intelligent control. Instead of having just anode and cathode for the LEDs, they have digital inputs and outputs as can be seen in FIG. 9, illustrating by means of example LC8823-5050 RGB SMD LED Datasheet. Up to now these inputs are only used to ‘input’ the PWM digital value which then is used internally to generate a certain PWM that drives the internal constant current sources to light up the LEDS.

However, it is part of the invention to apply the calibration and/or sub-delta correction also as local solution by means of chip implementation (for example LED chip or driver chip). This can either be A, the mathematical approach wherein all the factors are determined by a protocol to fill in the values, or B, a total lookup table for every color, wherein the lookup table is also loaded by input protocol. Solution C can also be implemented in exact the same way as described earlier, for example acting on the individual LED.

In general, the invention of adding a lookup table for (brightness and/or color) compensation in this kind of LEDs is considered to be inventive and new to overcome all the above-mentioned issues, such as for example sequential processing being more time consuming (and possibly requiring more resources) than now distributed and/or parallel processing (e.g. locally) in accordance with the invention. Further on, adding the complexity closer to the LEDs reduces the complexity (and size) of the control for an LED display.

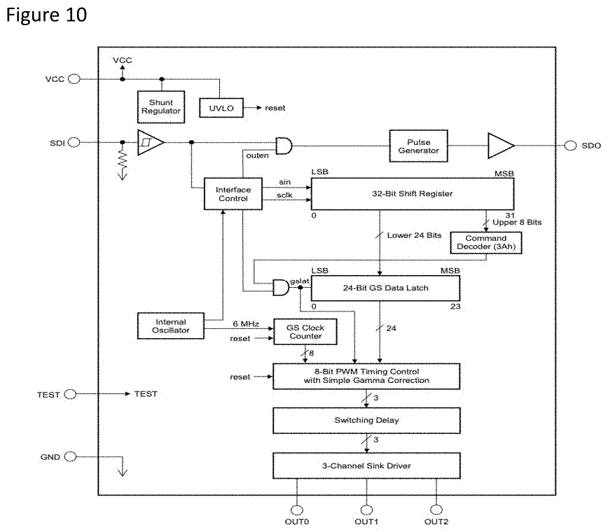

Now, not necessarily the LED needs to be in the same package. Constant current drivers (common cathode or common anode) are readily available such as e.g. TLC59731, a 3 channel 8-bit PWM driver with a single wire interface, wherein the out0, out1 and out2 and 3 pins are to be connected to the LEDs as depicted in FIG. 10, illustrating by means of example TLC59731 electronic diagram of the Texas Instruments (TI) 3-channel, 8-bit, PWM LED driver with Single-Wire Interface.

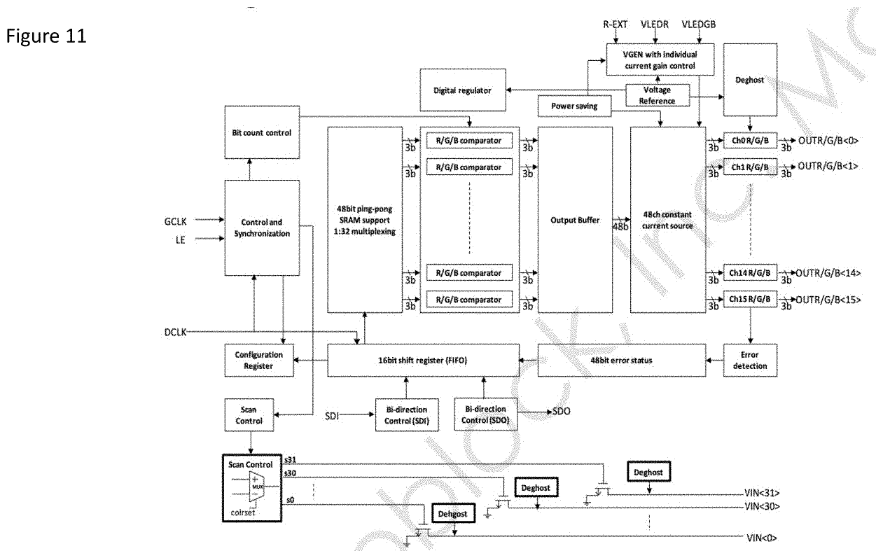

And more complex constant current drivers exist that can address multiple arrays of LEDs. Example here is e.g. MB15759 from Macroblock, i.e. an advanced LED driver built by 48 constant current source output channels and 32 switches packed into a compact BGA package. The block diagram of this (patented) 48-Channel PWM Constant Current LED Source Driver with Embedded Switch for 1:32 Time-multiplexing Applications is shown in FIG. 11. As one can see, there is memory (SRAM) in these drivers (to retain the LED PWM values), but no memory has ever been foreseen to hold individual LED calibration data nor non-linearity corrections within this kind of chips.

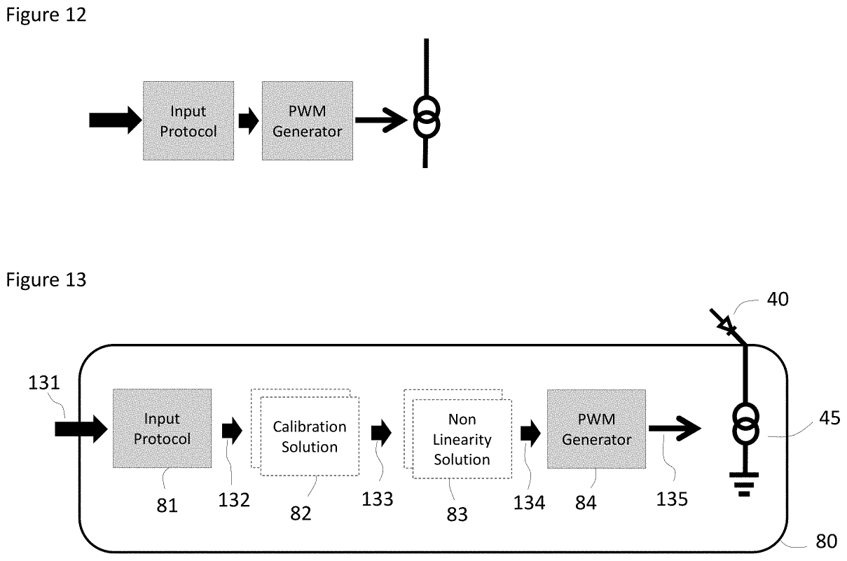

Oversimplified, the block diagrams are similar to all existing (integrated or not) LED drivers, as illustrated in FIG. 12, showing overall principal scheme. The input protocol is directed to the PWM generator, which is driving the LED.

Apart from the general methods described earlier, it is part of the invention to add functionality blocks in the ‘constant current driver’ chipsets with or without integrated LEDs, as illustrated in FIG. 13, showing again the overall principal scheme of FIG. 12 but now having also additional blocks (with dashed canvas) provided. A schematic embodiment is shown of the system 80 for a light-emitting display 10, in particular for driving light-emitting elements or pixels 40 thereof, with non-linear display pixel driver compensation. The system 80 comprises an input protocol 81 for receiving (video) input (to be displayed) and a PWM generating module 84 for transferring said input into signals to be delivered to pixel drivers 45, herewith defining and controlling the light-emitting elements or pixels 40 in the (light) output to be emitted by them (and displayed in the form of video). The system 80 also comprises an additional module 83 for determining and/or implementing non-linear display pixel driver compensation (due to non-linearities caused by the pixel drivers). The system 80 may further comprise a module 82 for performing calibration (in advance) and herewith determining calibration matrices to be used in defining the eventual output to be emitted by the light-emitting elements or pixels 40.

Further referring to FIG. 13, at the input of the system 80, video input is received 131 and entered via the input protocol 81, from which e.g. RGB data (16-bit) is delivered 132. This RGB data can then be calibrated via the module 82, out of which calibrated RGB data is now outputted 133. The calibrated RGB data can then be used as input for the non-linear compensation 83, out of which compensated (and earlier) calibrated data is coming 134. The compensated calibrated data can now be directed to the PWM generator 84, for generating and delivering 135 appropriate PWM signals via the pixel drivers 45 towards the LEDs or pixels 40 and herewith controlling them (by means of putting them in) on or off (state).

For the additional blocks 82, 83, it may be (as shown here) that multiple layers (or versions or phases) for the calibration 82 and for the non-linear compensation 83 (also called sub-delta) respectively are foreseen. Possibly such multiple layers need to be provided because of multiple colors and/or multiple types of LEDs for the calibration and/or the non-linear compensation has to be performed. It is noted that for each kind or set of colors, multiple instances can be added dependent on the complexity to solve. In general, one can state that every individual RGB pixel needs at least one set of calibration data (9 values). In case of visual perception enhancement, a set of 18 values is needed and in case of additional temperature compensation, a set of 3 extra values for each color is needed. If all the individual colors R, G, B (or others) have same non-linearity behavior, at least 3 non-linearity compensation blocks need to be added.

Reason of Non-Linearities

Multiple reasons can exist for non-linearities. Some reasons (but not limited to all reasons) are:
1. Layout capacitance of a LED board;
2. Temperature behavior of the constant current drivers;
3. Speed of the on/off switching of the constant current drivers; and
4. DI/DV (voltage and load dependence of the constant current drivers).

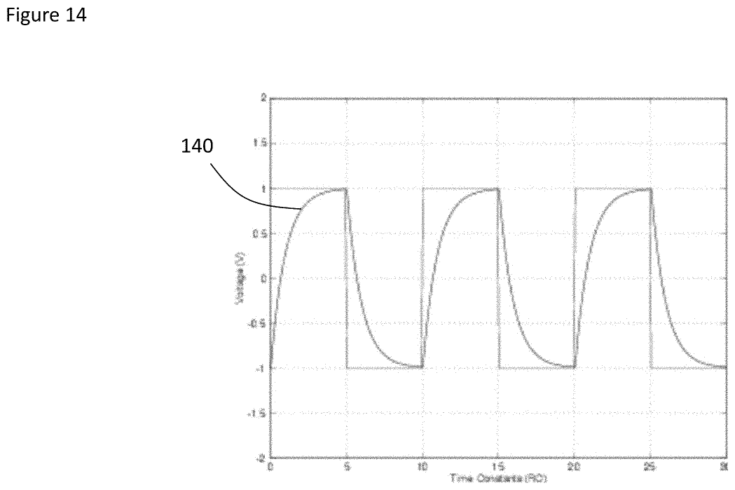

FIG. 14 shows an exemplary embodiment of a curve 140 exhibiting RC effect. The surface below the curve peaks is the energy for lighting the LEDs and dependent on the PWM width, this energy varies.

It is known from the industry that perfect constant current drivers don't exist. Most of these have a dependency on current needed and also supply voltage and can be found in the data sheets.

Example excerpt from constant current driver (MB15759 from Macroblock) datasheet:
Constant output current range:
   −0.5˜15 mA@ V_{DD}=V_{LEDGB}=3.8V, V_{LEDR}=2.8V supply voltage
Excellent output current accuracy:
   Between channels: <±2.5% (Max.)
   Between ICs: <±3.0% (Max.)

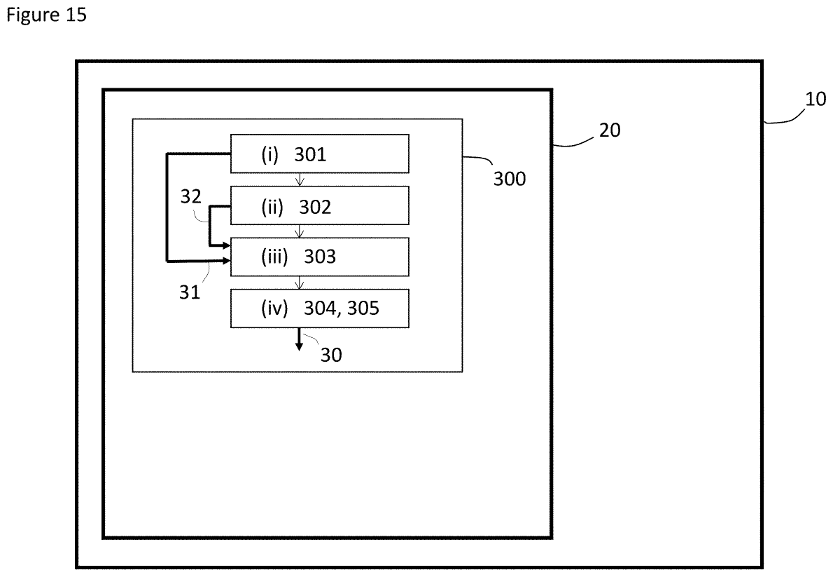

FIG. 15 illustrates a schematic embodiment of the method 300 for determining non-linear display pixel driver compensation 30 performed by a processing system 20 of a light-emitting display 10 characterized by one or more colors, for example three primary colors red, green and blue (RGB). The light-emitting display 10 comprises of pixels 40 being controlled by pixel drivers 45. The method 300 comprises of several steps, here represented as four in total. In a first step (i), values 31 are measured 301 for one or more colors 15 and/or for one or more pixels 40 of the display 10. Such values 31 can also be referred to as color values, and are e.g. measured on-display and taken real-time. The color measurement for achieving measured values 31, can be performed e.g. with a spectrometer. The values 31 can be represented in color space or linear space, defined by 3 coordinates (x, y, Y) or (X, Y, Z) respectively. In a second step (ii), the theoretical color values 32 are calculated 302 for the one or more colors 15 and/or for the one or more pixels 40 of the display 10, whereas such calculation is based on a linear relationship. In a third step (iii), the measured and corresponding calculated values 31, 32 are compared 303. In a fourth step (iv), a deviation in the measured values 31 (as compared to the calculated values 32) is observed 304, e.g. per color and for at least one color, due to non-linearities, particularly caused by the pixel drivers 45, and said deviation is determined 305 as the non-linear pixel driver compensation 30.

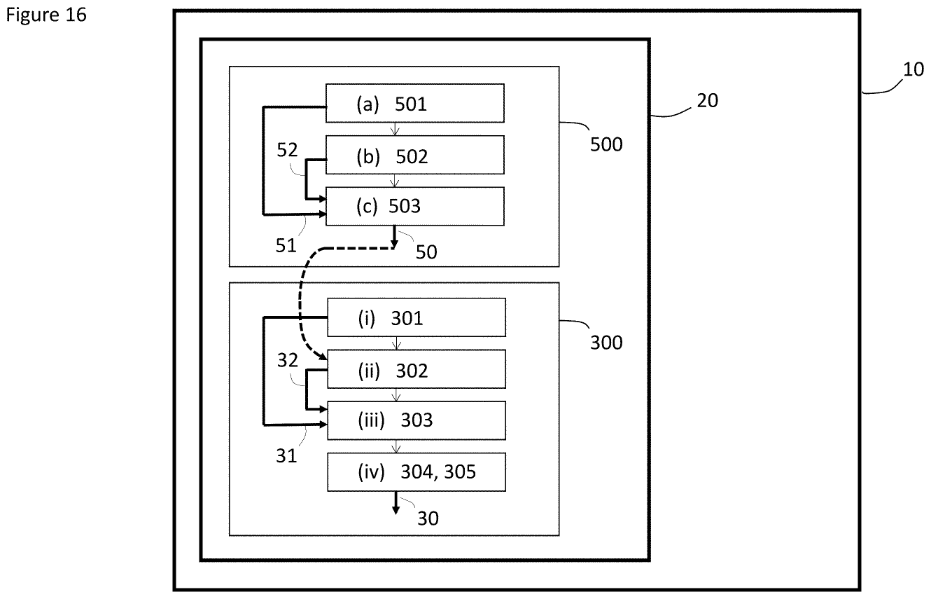

As depicted in FIG. 16, the method 300 may comprise, initially, of a calibration part 500. The initial calibration 500, performed prior to the four steps (i) to (iv) as described above, comprises of three steps (a) to (c). A first step (a) comprises of reading, loading or inputting 501 the so-called native color values 51 (in 3-coordinates representation) measured, e.g. with a spectrometer, for the one or more colors 15 of (each of the pixels 40 of) the display 10. A second step (b) comprises of reading, loading or inputting 502 the target values 52 (as being perceived by a human eye and/or a camera recording the display output) for the one or more colors 15 of (each of the pixels 40 of) the display 10. A third step (c) comprises of computing 503 (via matrix operations), for the one or more colors 15, corresponding calibration matrices 50 based on the measured and target values 51, 52, in particular based on the difference there between. Referring back to the method 300, when now calculating 302 the theoretical color values 32 in step (ii), the calibration matrices 50 as calculated by means of the method 500 are used as indicated by the dashed line arrow.

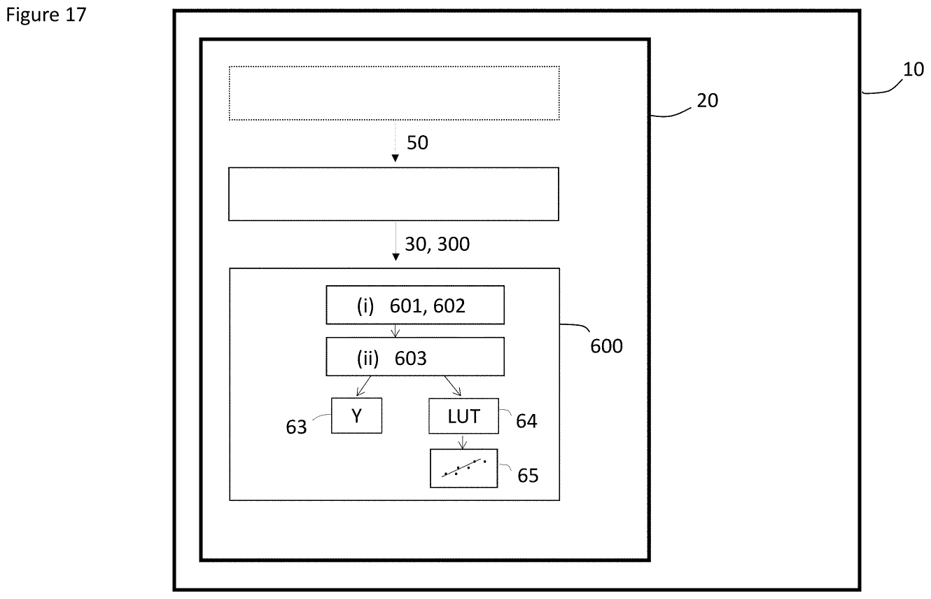

FIG. 17 illustrates a schematic embodiment of the method 600 for implementing non-linear display pixel driver compensation 30 performed by a processing system 20 of a light-emitting display 10 characterized by one or more colors 15, for example three primary colors red, green and blue (RGB). The light-emitting display 10 comprises of pixels 40 being controlled by pixel drivers 45. The method 600 comprises of several steps. In a first step (i), the non-linear display pixel driver compensation 30 based on the method 300 is determined 601, or the non-linear display pixel driver compensation 30, determined based on the method 300, is read, loaded or inputted 602. A second step (ii) comprises of compensating 603 for the deviation determined as the non-linear pixel driver compensation 30. Said compensating 603 can be based on the brightness (Y-value of color space coordinates) defined by a mathematical formula, as indicated by the module 63. Said compensating 603 can be based on the use of one or more lookup tables (of which data being stored in (non-volatile) memory) as indicated by the module 64, in particular on what is stored in the one or more lookup tables, each comprising of input values and corresponding output values taking into account the non-linearities. Moreover, said compensating 603 can be based on what is stored in a plurality of lookup tables having reduced bit-representation (in order to reduce the amount of memory required), in particular said compensating 603 being defined from interpolation computations, indicated by the module 65, performed amongst these.

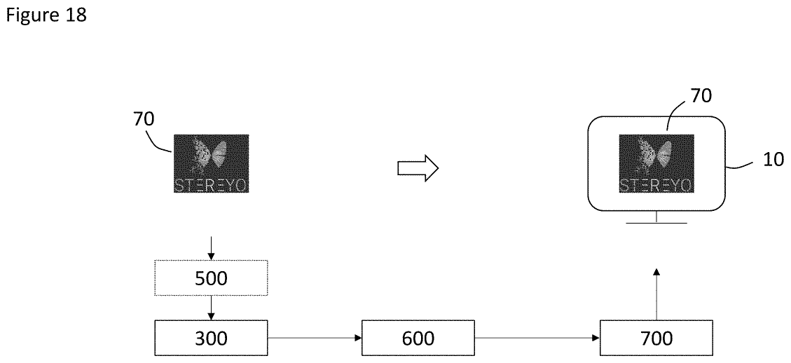

FIG. 18 illustrates a schematic embodiment of the method for displaying an image 70 on a light-emitting display 10 with non-linear display pixel driver compensation. The method may initially comprise of a calibration part 500, although this is not strictly necessary, as indicated by the dotted canvas of this block 500. The method comprises of determining the non-linear display pixel driver compensation based on the method 300, or reading, loading or inputting the non-linear display pixel driver compensation, determined based on the method 300 (hence indicated by block 300), and then implementing the non-linear display pixel driver compensation based on the method 600 (hence indicated by block 600). Next, the method comprises of displaying 700 the image 70 on the display 10 (as indicated by block 700). According to an embodiment, the method may comprise an additional temperature correction (not shown).

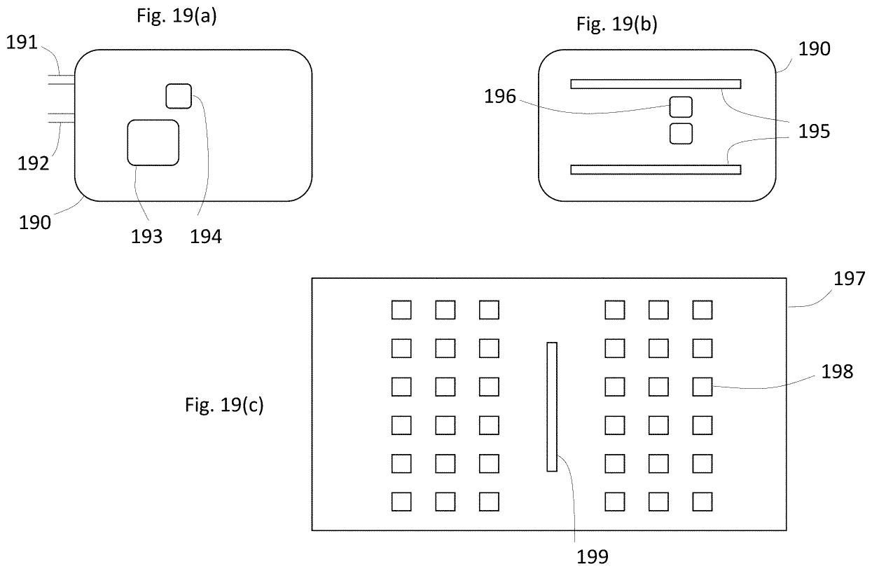

FIGS. 19(a), 19(b), and (19(c) illustrate an embodiment of the processing system of a light-emitting display, being provided with non-linear display pixel driver compensation, in accordance with the invention. In FIG. 19(a) and FIG. 19(b) an embodiment is shown of a so-called receiver card 190 (or processing system) which can be provided in or onto a display tile. In particular, in FIG. 19(a), one side (or front side) of the receiver card 190 is shown, whereas FIG. 19(b) illustrates the other side (or back side) of this card 190. Referring back to FIG. 19(a), here the video input 191 and video output 192 ports are depicted, for inputting and outputting the video stream, or in other words, for receiving the video input 191 and transmitting the video output 192 respectively. Further is shown an FPGA 193 (with processor) and a non-volatile memory 194 on this side of the card 190. The non-volatile memory 194 for example contains or stores data that is needed to make up or fill in the lookup table(s). This data can be inputted e.g. after having performed measurements and calculations of the non-linearities. The other side of the receiver card 190 in FIG. 19(b) illustrates an interface connection 195 represented by two rod-like connectors, as well as volatile memory 196, which can be used for instance to store calibration matrices. The interface connection 195 is to be linked to or connected with a connection 199 on a LED board 197, of which an exemplary embodiment is schematically represented in FIG. 19(c). The LED board 197 comprises a plurality of constant current drivers 198, all being connected with the connection 199. As we yet know, a constant current driver 198 can be used to control a pixel or LED, or a plurality thereof. It is common that one constant current driver 198 controls a cluster of pixels or LEDs, e.g. a multiple of 16 i.e. for example 64 or 256.

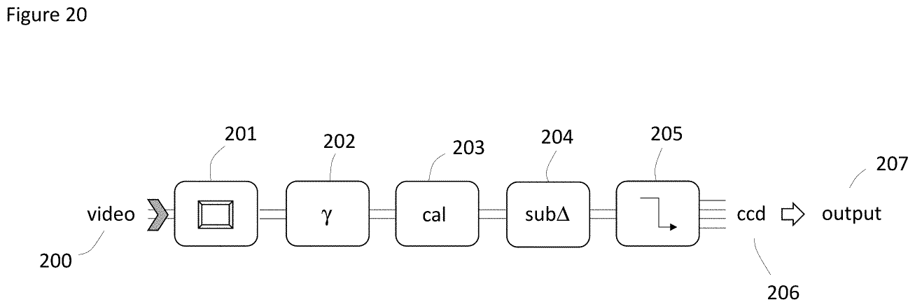

FIG. 20 illustrates another video pipeline embodiment, in accordance with the invention. The video 200 signal comes in as being received by the display system (and its processing), and a position or window 201 is defined and stored. Next, every color of a pixel goes through a gamma (or y) correction 202, followed by calibration 203. Further, the sub-delta (or subΔ) compensation 204 is performed, for which for example a lookup table is made (by means of input received from the processor) and subsequently sub-delta being determined. Then, as indicated by block 205, RGB is processed and signals are submitted to the constant current drivers 206 (depending e.g. on type of constant current driver (ccd), amount of pixels or LEDs, type of board etc.), finally leading to the light output 207 (in the form of a video image) being emitted by the LEDs or pixels, being controlled by the constant current driver(s). It is noted that as programming language, VHDL can be used, or alternatively Verilog is also applicable.

Combinability of Embodiments and Features

This disclosure provides various examples, embodiments, and features which, unless expressly stated or which would be mutually exclusive, should be understood to be combinable with other examples, embodiments, or features described herein.

In addition to the above, further embodiments and examples include the following:
1. A method (300) for determining non-linear display pixel driver compensation (30) performed by a processing system (20) of a light-emitting display (10) characterized by one or more colors (15), said light-emitting display (10) comprising of pixels (40) being controlled by pixel drivers (45), the method (300) comprising: (i) measuring (301) values (31) for at least one of the one or more colors; (ii) calculating (302) values (32) for the at least one of the one or more colors; (iii) comparing (303) measured and corresponding calculated values; (iv) observing (304) a deviation in the measured values due to non-linearities, and determining (305) said deviation as the non-linear pixel driver compensation (30).
2. The method (300) of 1 above or 3 to 12 below, wherein prior to all steps (i) to (iv), calibration (500) is performed by means of (a) reading, loading or inputting (501) the values (51) measured for the one or more colors of the display (10); (b) reading, loading or inputting (502) the target values (52) for the one or more colors of the display (10); and (c) for the one or more colors, computing (503) corresponding calibration matrices (50) based on the measured and target values (51, 52); and when calculating values (32) in step (ii) the calibration matrices (50) being used.
3. The method (300) of 2, wherein the calibration matrices (50) are based on display content contexts and/or display set-ups.
4. The method (300) of 1 to 3 above or 5 to 12 below, wherein the light-emitting display (10) is characterized by at least three colors.
5. The method (300) of 1 to 4 above or 6 to 12 below, wherein the determining is performed for each display pixel or cluster of display pixels.
6. A method (600) for implementing non-linear display pixel driver compensation (30), performed by a processing system (20) of a light-emitting display (10) characterized by one or more colors (15), said light-emitting display (10) comprising of pixels (40) being controlled by pixel drivers (45), the method (600) comprising: (i) determining (601) the non-linear display pixel driver compensation (30) based on the method (300) of 1 to 5 above, or reading, loading or inputting (602) the non-linear display pixel driver compensation (30), determined based on the method (300) of 1 to 5 above, and (ii) compensating (603) for said deviation determined as the non-linear pixel driver compensation (30).
7. The method of 6 above, wherein said compensating (603) is based on the brightness defined by a mathematical formula.
8. The method of 6 above, wherein said compensating (603) is based on the use of one or more lookup tables, in particular on what is stored in the one or more lookup tables, each comprising of input values and corresponding output values taking into account the non-linearities.
9. The method of 8 above, wherein said compensating (603) is based on what is stored in a plurality of lookup tables having reduced bit-representation, in particular said compensating being defined from interpolation computations performed amongst these.
10. The method of 6 to 9 above or 12 below, wherein said compensating (603) is performed for each display pixel or cluster of display pixels.
11. A method for displaying an image (70) on a light-emitting display (10) with non-linear display pixel driver compensation (30), comprising: (i) determining the non-linear display pixel driver compensation (30) based on the method (300) of 1 to 5 above, or reading, loading or inputting the non-linear display pixel driver compensation (30), determined based on the method (300) of 1 to 5 above; (ii) implementing the non-linear display pixel driver compensation (30) based on the method (600) of 6 to 10 above; and (iii) displaying (700) the image (70) on the display (10).
12. The method of 1 to 11 above, wherein an additional temperature correction is applied.
13. A system (80) for a light-emitting display (10), in particular for driving light-emitting elements or pixels (40) thereof, comprising an input protocol (81) for receiving input and a PWM generating module (84) for transferring said input into signals to be delivered to pixel drivers (45), herewith defining and controlling the light-emitting elements or pixels (40) in the output to be emitted by them, characterized in that said system (80) comprises a module (83) for determining and implementing non-linear display pixel driver compensation (30) according to the method (300, 600) of 1 to 5 above and 6 to 10 above, respectively.
14. The system (80) of 13, further comprising a module (82) for performing calibration (500) and herewith determining calibration matrices (50) to be used in defining the output to be emitted by the light-emitting elements or pixels (40).
15. The system (80) of 13 above, wherein said compensating of the method (600) for implementing non-linear display pixel driver compensation (30), is particularly based on the use of one or more lookup tables and the data for this one or more lookup tables being stored in and hence to be fetched from a non-volatile memory of the processing system (20), said one or more lookup tables each comprising of input values and corresponding output values taking into account the non-linearities to be incorporated in the signals for the pixel drivers (45).
16. A system comprising:
   a light-emitting display including light-emitting elements or pixels, the light-emitting display comprising an input protocol for receiving input and a PWM generating module for transferring said input into signals to be delivered to pixel drivers, herewith defining and controlling the light-emitting elements or pixels in the output to be emitted by them; and
   a module for determining and implementing non-linear display pixel driver compensation (30) according to the method of one or a combination of 1 to 12 above.
17. One or more computer-readable mediums have instructions stored thereon, which, when executed by one or more processors of a system for driving light-emitting elements or pixels, causes the one or more processors to perform the method according to one or a combination of 1 to 12 above.

1. A method for determining non-linear display pixel driver compensation performed by a processing system of a light-emitting display having one or more colors, said light-emitting display comprising pixels controlled by pixel drivers, the method comprising:
(i) measuring values for at least one of the one or more colors;
(ii) calculating values for the at least one of the one or more colors;
(iii) comparing measured and corresponding calculated values;
(iv) observing a deviation in the measured values due to non-linearities, and determining said deviation as the non-linear pixel driver compensation.

2. The method of claim 1, wherein prior to all steps (i) to (iv), calibration is performed by means of (a) reading, loading or inputting the values measured for the one or more colors of the display; (b) reading, loading or inputting the target values for the one or more colors of the display; and (c) for the one or more colors, computing (503) corresponding calibration matrices based on the measured and target values; and when calculating values in step (ii) the calibration matrices being used.

3. The method of claim 2, wherein the calibration matrices (50) are based on display content contexts and/or display set-ups.

4. The method of claim 1, wherein the light-emitting display is characterized by at least three colors.

5. The method (300) of claim 1, wherein the determining is performed for each display pixel or cluster of display pixels.

6. A method for implementing non-linear display pixel driver compensation, performed by a processing system of a light-emitting display having one or more colors, said light-emitting display comprising of pixels being controlled by pixel drivers, the method comprising:
determining the non-linear display pixel driver compensation based on the method of claim 1, or reading, loading or inputting the non-linear display pixel driver compensation, determined based on the method of claim 1, and
compensating for said deviation determined as the non-linear pixel driver compensation.

7. The method of claim 6, wherein said compensating is based on the brightness defined by a mathematical formula.

8. The method of claim 6, wherein said compensating is based on the use of one or more lookup tables, in particular on what is stored in the one or more lookup tables, each comprising of input values and corresponding output values taking into account the non-linearities.

9. The method of claim 8, wherein said compensating is based on what is stored in a plurality of lookup tables having reduced bit-representation, in particular said compensating being defined from interpolation computations performed amongst these.

10. The method of claim 6, wherein said compensating is performed for each display pixel or cluster of display pixels.

11. A method for displaying an image on a light-emitting display with non-linear display pixel driver compensation, comprising:
determining the non-linear display pixel driver compensation based on the method of claim 1, or reading, loading or inputting the non-linear display pixel driver compensation, determined based on the method of claim 1;
implementing the non-linear display pixel driver compensation based on
determining the non-linear display pixel driver compensation based on the method of claim 1, or reading, loading or inputting the non-linear display pixel driver compensation, determined based on the method of claim 1, and
compensating for said deviation determined as the non-linear pixel driver compensation; and
displaying the image on the display.

12. The method of claim 11, wherein an additional temperature correction is applied.

13. A system for driving light-emitting elements or pixels of a light-emitting display, the light-emitting display comprising an input protocol for receiving input and a PWM generating module for transferring said input into signals to be delivered to pixel drivers, herewith defining and controlling the light-emitting elements or pixels in the output to be emitted by them, the system comprising:
a module for determining and implementing non-linear display pixel driver compensation (30) according to the method of claim 1.

14. The system of claim 13, further comprising a module for performing calibration and herewith determining calibration matrices to be used in defining the output to be emitted by the light-emitting elements or pixels.

15. The system of claim 13, wherein said compensating of the method for implementing non-linear display pixel driver compensation, is particularly based on the use of one or more lookup tables and the data for this one or more lookup tables being stored in and hence to be fetched from a non-volatile memory of the processing system, said one or more lookup tables each comprising of input values and corresponding output values taking into account the non-linearities to be incorporated in the signals for the pixel drivers.

16. A system comprising:
a light-emitting display including light-emitting elements or pixels, the light-emitting display comprising an input protocol for receiving input and a PWM generating module for transferring said input into signals to be delivered to pixel drivers, herewith defining and controlling the light-emitting elements or pixels in the output to be emitted by them; and
a module for determining and implementing non-linear display pixel driver compensation (30) according to the method of claim 1.

17. One or more computer-readable mediums have instructions stored thereon, which, when executed by one or more processors of a system for driving light-emitting elements or pixels, causes the one or more processors to perform the method according to claim 1.
